(19) United States
(12) Patent Application Publication
(10) Pub. No.: US 2014/0055551 A1
(43) Pub. Date: Feb. 27, 2014

(54) IMAGE PROCESSING METHOD AND APPARATUS FOR PERSONAL PROTECTION IN VIDEO CALL

(71) Applicant: HANHWA SOLUTION & CONSULTING CO., LTD, Seoul (KR)

(72) Inventors: Jung Soo HONG, Gyeonggi-do (KR); Heung Soo PARK, Gyeonggi-do (KR)

(73) Assignee: HANHWA SOLUTION & CONSULTING CO., LTD, Seoul (KR)

(21) Appl. No.: 13/660,088

(22) Filed: Oct. 25, 2012

(30) Foreign Application Priority Data
Aug. 22, 2012 (KR) 10-2012-0091629

(51) Int. Cl. H04N 7/14

(52) U.S. Cl. 348/14.01; 348/E07.078

(57) ABSTRACT

An image processing method and apparatus for personal protection in a video call is provided. The image processing method in a communication terminal may include receiving an input of a video signal from a camera for a video call, recognizing a body shape of a user, by detecting a body outline of the user captured by the camera in an image included in the video signal, processing an area corresponding to the body shape to be in a form of a silhouette, in order to protect exposure of a figure and an identity of the user while maintaining an ambient image of the user in the video image, and transmitting the processed video image, as a final video signal for the video call, to at least one target communication terminal.

### CROSS-REFERENCE TO RELATED APPLICATION

This application claims the benefit of Korean Patent Application No. 10-2012-0091629, filed on Aug. 22, 2012, in the Korean Intellectual Property Office, the disclosure of which is incorporated herein by reference.

### BACKGROUND

1. Technical Field

This disclosure relates to an image processing method and apparatus that may protect a figure of a person while preserving a sense of presence in a video call.

2. Description of the Related Art

With a development of mobile communication technology and terminal manufacturing technology, recent mobile communication terminals are not limited to being used as a device for making a voice call while on the move. Instead, the mobile communication terminals provide a variety of additional functions. For example, the mobile communication terminals may be used to exchange photos with others, to download videos from a server, to play an online game using a wireless Internet connection, and the like. In particular, as a mobile communication terminal including a high-performance camera is being used more widely, a video call function is garnering greater attention. In addition, the commercialization of technologies, for example, high speed downlink packet access (HSDPA) which allows high speed data transmission, and the like, leads to a rapid increase in usage of a video call using a mobile communication terminal.

A video call may basically allow a user to perform a conversation with an interlocutor while seeing a face of the interlocutor, thereby providing the user with a sense of presence similar to being in front of the interlocutor. However, the user may not want to show his or her face or clothing depending on personal circumstances. In the past, the user may have handled such a situation by turning the camera to another side, or turning off the screen.

In addition, a video call in a conventional mobile communication terminal may have a possibility of invading privacy due to exposure of a place in which the user is located, and the like. Accordingly, a method of transmitting a substitute image has been suggested as a technology for resolving such an issue. In the method, a background of a captured image of the user may be replaced with another background, or an image of the user currently being captured may be replaced with another image previously captured and may be transmitted, rather than transmitting the image of the user currently being captured.

However, when the screen is turned off or a substitute image is displayed since the user is reluctant to expose an image of the user during a video call, conveying actual circumstances around the user may be difficult, and a sense of presence of the voice call may decrease. Accordingly, the interlocutor may feel frustrated, and the communication may be unsuccessful.

Herein, an image processing technology for protecting a figure of an individual while preserving a sense of presence, by maintaining an ambient image of the user during a video call, will be described.

### SUMMARY

An image processing method and apparatus are disclosed that may protect a figure of an individual on a video screen while preserving a sense of presence during a video call.

An image processing method and apparatus are disclosed that may process a body shape of a user to be in a form of a silhouette while maintaining an image around the user on a video screen during a video call.

An image processing method in a communication terminal is also disclosed, the method including receiving an input of a video signal from a camera for a video call, recognizing a body shape of a user, by detecting a body outline of the user captured by the camera in an image included in the video signal, processing an area corresponding to the body shape to be in a form of a silhouette, in order to protect exposure of a figure and an identity of the user while maintaining an ambient image of the user in the video image, and transmitting the processed video image, as a final video signal for the video call, to at least one target communication terminal.

The processing may include processing color information of an internal portion of the area corresponding to the body shape with a single color.

The processing may include processing a color of the internal portion of the area corresponding to the body shape with a color designated by the user.

The processing may include processing an internal portion of the area corresponding to the body shape to be blurred using a mosaic.

The processing may include processing the area corresponding to the body shape to be displayed in a form of numbers or letters.

### BRIEF DESCRIPTION OF THE DRAWINGS

These and/or other aspects, features, and advantages will become apparent and more readily appreciated from the following description of exemplary embodiments, taken in conjunction with the accompanying drawings of which:

FIG. 1 is a block diagram illustrating an internal configuration of a communication terminal configured to process a body shape of a user to be in a form of a silhouette during a video call according to an embodiment of this disclosure;

FIG. 2 is a diagram illustrating an example of a user menu associated with a silhouette function according to an embodiment of this disclosure;

FIG. 3 is a diagram illustrating an example of processing a body shape of a user to be in a form of a silhouette, in an input video source, according to an embodiment of this disclosure; and

FIG. 4 is a flowchart illustrating an image processing method in a communication terminal configured to process a body shape of a user to be in a form of a silhouette during a video call according to an embodiment of this disclosure.

### DETAILED DESCRIPTION

Reference will now be made in detail to exemplary embodiments, examples of which are illustrated in the accompanying drawings, wherein like reference numerals refer to the like elements throughout. Exemplary embodiments are described below by referring to the figures.

The exemplary embodiments described below may be applied to a communication terminal that supports a one-to-one video call or one-to-many video call. Herein, the term “communication terminal” may refer to all communication terminals that include a video call function, for example, a personal computer (PC), a tablet computer, a smart phone, and the like.

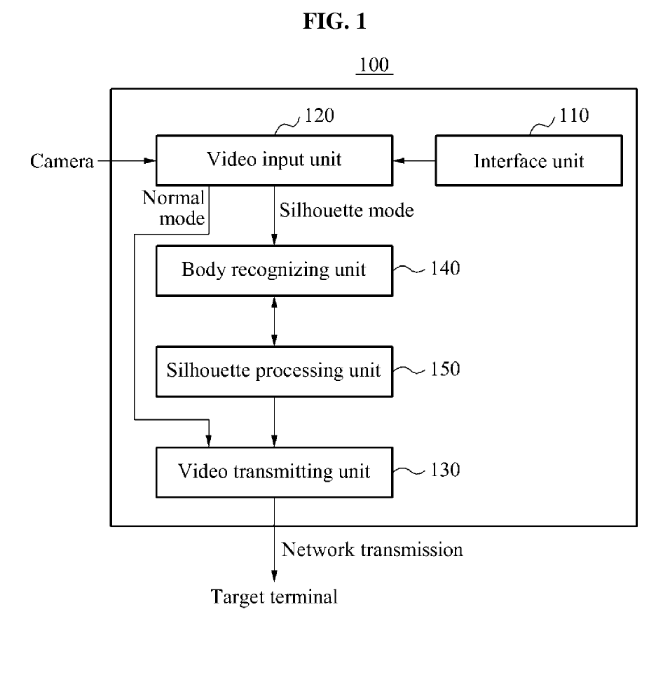

FIG. 1 is a block diagram illustrating an internal configuration of a communication terminal configured to process a body shape of a user to be in a form of a silhouette during a video call according to an embodiment.

Referring to FIG. 1, a communication terminal 100 may include an interface unit 110, a video input unit 120, a video transmitting unit 130, a body recognizing unit 140, and a silhouette processing unit 150. In this instance, the communication terminal 100 may be configured to include an internal camera, or to be connected to a separate external camera, for a video call.

The interface unit 110 may receive, from a user, an input of information indicating whether a silhouette function is to be performed for a video call. Herein, the silhouette function may refer to processing a body shape of the user to be in a form of a silhouette, in an input video source, in order to prevent exposure of a face or clothing of the user during a video call. In this instance, the interface unit 110 may provide a user menu associated with the silhouette function.

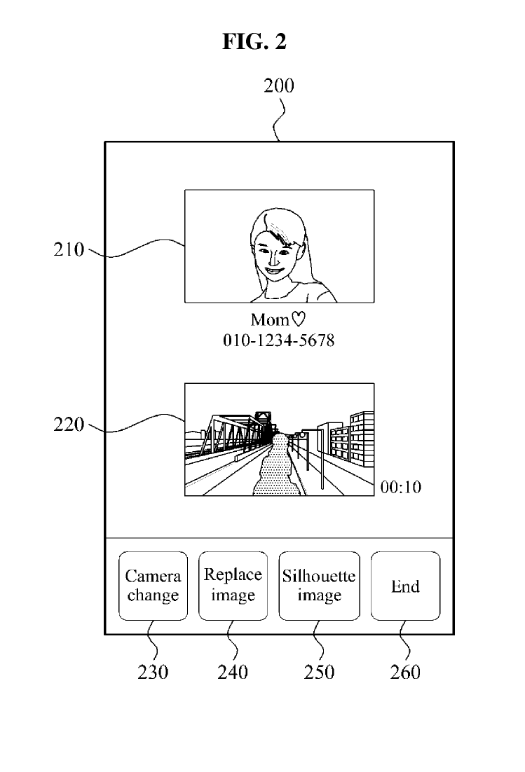

Referring to FIG. 2, during an outgoing call or incoming call, an interlocutor video screen 210 on which a video of an interlocutor is displayed, and a user video screen 220 on which a video of the user is displayed may be displayed on a video call screen 200. In addition, various menus associated with the video call may be activated on the video call screen 200. For example, a camera change menu 230 to change a direction of a camera, a replace image menu 240 to transmit a substitute image instead of the video of the user, and an end menu 260 to terminate a video call may be activated. The interface unit 110 may include, in the user menu associated with the video call, a silhouette image menu 250 to perform a silhouette function through the video call screen 200. That is, the user may utilize the silhouette function during the video call, by executing the silhouette image menu 250, among the user menus activated on the video call screen 200, in a situation in which the interlocutor may view the video of the user. The interface unit 110 may receive, from the user, an input of additional information associated with the silhouette function. In this instance, the additional information may include a color, a number, a letter, and the like that may be applied when the silhouette processing is performed.

The video input unit 120 may receive the input video source, that is, a video signal, from a camera, for a video call. In this instance, when a separate request for execution of the silhouette function is not input through the interface unit 110, hereinafter referred to as a “normal mode,” the video input unit 120 may immediately transfer, to the video transmitting unit 130, the video signal input from the camera. Conversely, when the request for execution of the silhouette function is input through the interface unit 110, hereinafter referred to as a “silhouette mode,” the video input unit 120 may transfer the video signal input from the camera to the body recognizing unit 140.

The video transmitting unit 130 may transmit the video signal for the video call to at least one target communication terminal, hereinafter referred to as “target terminal.” For a one-to-one video call or one-to-n video call depending on a request from the user, the video transmitting unit 130 may transmit the video signal of the user to the at least one target terminal in real time, using connection information of at least one interlocutor designated by the user. Here, the connection information may include, for example, a phone number, and the like. In this instance, in a case of the normal mode, the video transmitting unit 130 may receive the video signal from the video input unit 120, and may transmit the received video signal to the at least one target terminal. In a case of the silhouette mode, the video transmitting unit 130 may receive the video signal from the silhouette processing unit 150, and may transmit the received video signal to the at least one target terminal.

The silhouette mode of the video call may be performed by the body recognizing unit 140 and the silhouette processing unit 150.

In the silhouette mode, the body recognizing unit 140 may receive an input of the video signal from the video input unit 120, and may recognize a body shape of the user captured by the camera, in the input video signal. The body recognizing unit 140 may distinguish a body of the user from a background in an image included in the video signal, based on a brightness, a motion, a color, information obtained by estimating a position of a face of the user, or information obtained by estimating a position of an eye of the user. For example, the body recognizing unit 140 may detect a body outline in the image included in the video signal, based on various algorithms, for example, a scheme of detecting an edge in a gray image, a scheme of detecting an edge using a disparity map according to a difference in brightness, and the like.

The silhouette processing unit 150 may process an area corresponding to the body shape recognized by the body recognizing unit 140 in the video signal, to be in a form of a silhouette. As an example, the silhouette processing unit 150 may perform the silhouette processing, by maintaining color information of an area corresponding to the background in the video signal, and changing color information of the area corresponding to the body shape in order to prevent exposure of the face or clothing of the user. In other words, the silhouette processing unit 150 may process an internal portion of a body outline detected by the body recognizing unit 140 with a single color. In this instance, a color designated by the user through the interface unit 110 may be applied to the internal portion of the silhouette. As another example, the silhouette processing unit 150 may perform the silhouette processing, using a scheme of processing the area corresponding to the body shape using a mosaic, for preserving a sense of presence. As still another example, the silhouette processing unit 150 may perform the silhouette processing so that numbers or letters may be displayed in the area corresponding to the body shape. In this instance, the numbers or letters applied when the silhouette processing is performed may be input directly by the user through the interface unit 110. In this example, when three users participate in a video call, numbers 1, 2, and 3 may be displayed in an area corresponding to a body area of each user so that each user may be recognized readily on a video screen. Accordingly, when a video call is performed among multiple users, a body area of each user may be processed to be displayed in a form of numbers or letters, whereby recognition with respect to each user may be increased on the processed video screen.

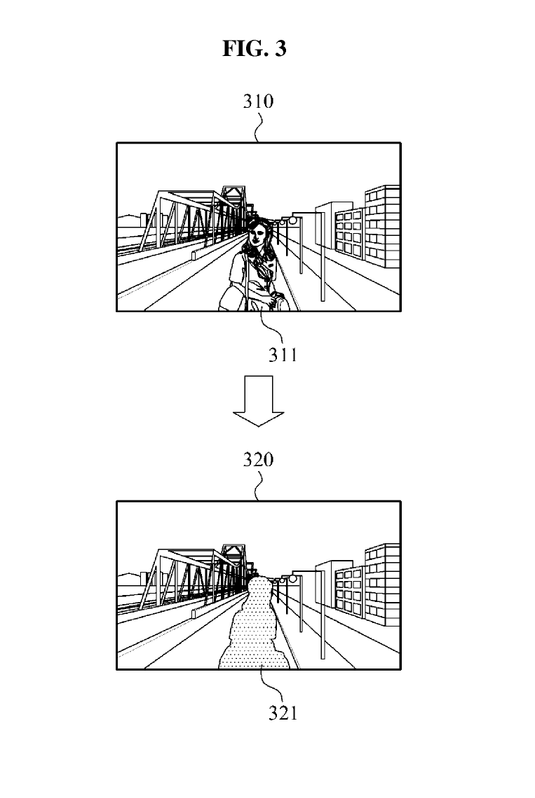

Referring to FIG. 3, an internal portion of an outline of a body shape 311 detected in an original video 310 may be processed to be in various forms of silhouettes. A video 320 including a processed body shape 321 may be used as a final video to be transmitted to a target terminal.

The silhouette processing unit 150 may transfer the processed video signal to the video transmitting unit 130 so that the processed video signal may be transmitted to the at least one target terminal. In addition, the silhouette processing unit 150 may output the processed video signal to a terminal monitor device (not shown) so that an image included in the processed video signal may be viewed by the user as well. Accordingly, the processed video signal may be displayed on both a screen provided to the user and a screen provided through the at least one target terminal and thus, the image included in the processed video signal may be viewed by both the user and the interlocutor.

According to the configuration described above, a figure of the user on the video screen may be protected, by processing the body shape of the user in the input video source for the video call to be in a form of a silhouette.

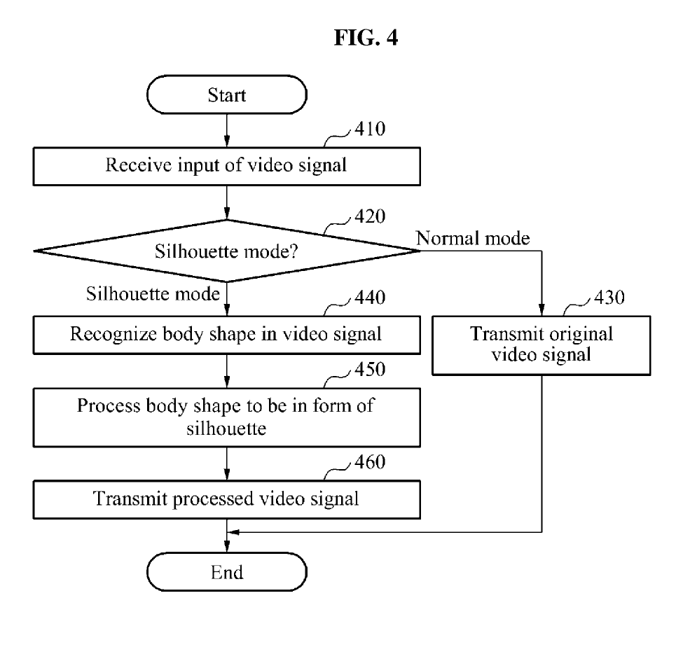

FIG. 4 is a flowchart illustrating an image processing method in a communication terminal configured to process a body shape of a user to be in a form of a silhouette during a video call according to an embodiment of this disclosure. Each operation of the image processing method of FIG. 4 may be performed by the communication terminal 100 of FIG. 1.

In operation 410, the communication terminal 100 may receive an input of a video signal from a camera for a video call.

In operation 420, the communication terminal 100 may verify whether a silhouette function for the video call is to be performed by a user. The communication terminal 100 may provide a silhouette image menu to perform the silhouette function through a video call screen during an outgoing call or incoming call. Accordingly, the user may perform the silhouette function during the video call, using the provided silhouette image menu.

When the video call in a normal mode is requested by the user, as opposed to performing the silhouette function, the communication terminal 100 may transmit, to at least one target terminal, the original video signal input from the camera, in operation 430.

However, when the user requests a video call in a silhouette mode by performing the silhouette function, the communication terminal 100 may recognize a body shape of the user captured by the camera in the video signal input from the camera, in operation 440. In this instance, the communication terminal 100 may distinguish a body of the user from a background in the video signal, by detecting an outline of the body in an image included in the video signal.

In operation 450, the communication terminal 100 may process an area corresponding to the body shape recognized in operation 440, to be in a form of a silhouette. As an example, when the body shape is distinguished from the background based on the outline of the body in the video signal, the communication terminal 100 may process an internal portion of the outline of the body shape with a single color while maintaining original color information of a background area corresponding to an ambient area in the video signal. In this instance, a color designated by the user may be applied to the internal portion of the silhouette. As another example, the communication terminal 100 may perform the silhouette processing, using a scheme of processing the internal portion of the silhouette using a mosaic, for preserving a sense of presence. As still another example, the communication terminal 100 may perform the silhouette processing so that numbers or letters may be displayed in the area corresponding to the body shape, that is, in the internal portion of the silhouette. In this instance, the numbers or letters applied when the silhouette processing is performed may be input directly by the user.

In operation 460, the communication terminal 100 may transmit the processed video signal to at least one target terminal. In this instance, the communication terminal 100 may also output the processed video signal through a screen to be provided to the user.

According to exemplary embodiments, by processing only a body shape of a user to be in a form of a silhouette while maintaining an ambient image of the user in an input video source, exposure of a face or clothing of the user may be prevented while simultaneously preserving essential functions of a video call and a sense of presence. Accordingly, the silhouette function may be useful for various video services, for example, a video call, a video conference, and the like and thus, such video services may be refreshed. In addition, when direct participation in a video call is requested while avoiding exposure of an identity, for example, in a case of a remote examination of a suspect, the silhouette function may be effectively utilized. Furthermore, the sense of presence of the video call may be improved by processing an internal portion of the silhouette using a mosaic. By processing the internal portion of the silhouette with a color designated directly by the user or by displaying numbers of letters in the internal portion of the silhouette, recognition may be increased on the processed video screen.

The above-described exemplary embodiments may be recorded in computer-readable media including program instructions to implement various operations embodied by a computer. The media may also include, alone or in combination with the program instructions, data files, data structures, and the like. The program instructions stored in the media may be specially designed and configured, or may be known to those skilled in the art and thereby be implemented.

According to exemplary embodiments, a figure of a user on a video screen may be protected by processing a body shape of the user to be in a form of a silhouette, in an input video source for a video call.

According to exemplary embodiments, by processing only a body shape of a user to be in a form of a silhouette while maintaining an image around the user in an input video source, essential functions of a video call and a sense of presence may be preserved, and simultaneously exposure of a face or clothing of the user may be prevented.

By processing an internal portion of a silhouette with a color designated directly by a user, or by displaying numbers or letters in the internal portion of the silhouette, recognition with respect to an interlocutor on a video screen may be increased.

Accordingly, a silhouette function may be useful for various video services, for example, a video call, a video conference, and the like and thus, such video services may be refreshed. In addition, when direct participation in a video call is requested while avoiding exposure of an identity, for example, in a case of a remote examination of a suspect, the silhouette function may be effectively utilized.

Although a few exemplary embodiments have been shown and described, this disclosure is not limited to the described exemplary embodiments. Instead, it would be appreciated by those skilled in the art that changes may be made to these exemplary embodiments without departing from the principles and spirit of this disclosure, the scope of which is defined by the claims and their equivalents.

What is claimed is:

1. An image processing method in a communication terminal, the method comprising:
receiving an input of a video signal from a camera for a video call;
recognizing a body shape of a user, by detecting a body outline of the user captured by the camera in an image included in the video signal;
processing an area corresponding to the body shape to be in a form of a silhouette, in order to protect exposure of a figure and an identity of the user while maintaining an ambient image of the user in the video image; and
transmitting the processed video image, as a final video signal for the video call, to at least one target communication terminal.

2. The image processing method of claim 1, wherein the processing comprises processing color information of an internal portion of the area corresponding to the body shape with a single color.

3. The image processing method of claim 2, wherein the processing comprises processing a color of the internal portion of the area corresponding to the body shape with a color designated by the user.

4. The image processing method of claim 1, wherein the processing comprises processing an internal portion of the area corresponding to the body shape to be blurred using a mosaic.

5. The image processing method of claim 1, where in the processing comprises processing the area corresponding to the body shape to be displayed in a form of numbers or letters.
